(19) United States
(12) Patent Application Publication
(10) Pub. No.: US 2014/0152851 A1
(43) Pub. Date: Jun. 5, 2014

(54) Information Processing Apparatus, Server Device, and Computer Program Product

(71) Applicant: KABUSHIKI KAISHA TOSHIBA, Tokyo (JP)

(72) Inventors: Hidetaka Ohira, Kanagawa (JP); Kazuhide Sawa, Tokyo (JP); Masayuki Okamoto, Kanagawa (JP); Masaru Sakai, Ishikawa (JP); Masahiro Sekine, Tokyo (JP); Masashi Nishiyama, Kanagawa (JP)

(73) Assignee: KABUSHIKI KAISHA TOSHIBA, Tokyo (JP)

(21) Appl. No.: 14/024,202

(22) Filed: Sep. 11, 2013

(30) Foreign Application Priority Data
Dec. 3, 2012 (JP) 2012-264593

(51) Int. Cl. G06F 17/30

(52) U.S. Cl. CPC G06F 17/30244
USPC 348/207.1

(57) ABSTRACT

According to one embodiment, an information processing apparatus includes an image capturing module, an estimation module, a content obtaining module, and a display module. The image capturing module is configured to capture a subject to be captured. The estimation module is configured to estimate a state of the subject to be captured based on a capturing method for the subject to be captured by the image capturing module. The content obtaining module is configured to obtain the content based on the state of the subject to be captured and relating to the subject to be captured. The display module is configured to display the obtained content.

### CROSS-REFERENCE TO RELATED APPLICATIONS

This application is based upon and claims the benefit of priority from Japanese Patent Application No. 2012-264593, filed Dec. 3, 2012, the entire contents of which are incorporated herein by reference.

### FIELD

Embodiments described herein relate generally to an information processing apparatus, a server device, and a computer program product.

### BACKGROUND

Recently, technologies are known in which an image capturing module of a portable tablet information processing apparatus is held over a subject to be captured on a display screen of a television set, for example, to capture a person or content of the television program displayed on the display screen and display the contents according to the captured image. According to the previous technologies, a user can touch to select an intended subject out of the captured image displayed on a touch screen of the information processing apparatus, whereby the content according to the selected subject can be displayed.

By using these technologies, however, if captured images that can be selected by touch are all displayed on the screen on the information processing apparatus, the screen becomes complicated and thus a user can hardly search for contents corresponding to the intended subject readily and intuitively.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of the hardware structure of an information processing apparatus according to a first embodiment;

FIG. 2 is an exemplary diagram of the function structure of the information processing apparatus in the first embodiment;

FIG. 3 is an exemplary diagram for explaining how to hold the camera of the information processing apparatus in the first embodiment to a display screen of the television and an example of contents displayed on the information processing apparatus;

FIG. 4 is an exemplary diagram for explaining how to hold the camera of the information processing apparatus in the first embodiment to the display screen of the television and an example of contents displayed on the information processing apparatus;

FIG. 5 is an exemplary diagram for explaining how to hold the camera of the information processing apparatus in the first embodiment to the display screen of the television and an example of contents displayed on the information processing apparatus;

FIG. 6 is an exemplary diagram for explaining how to hold the camera of the information processing apparatus in the first embodiment to the display screen of the television and an example of contents displayed on the information processing apparatus;

FIG. 7 is an exemplary diagram for explaining how to hold the camera of the information processing apparatus in the first embodiment to the display screen of the television and an example of contents displayed on the information processing apparatus;

FIG. 8 is an exemplary flowchart of procedures of content display processing in the first embodiment;

FIG. 9 is an exemplary diagram of the network structure of an information processing system in a second embodiment;

FIG. 10 is an exemplary block diagram of the function structure of a server device according to the second embodiment;

FIG. 11 is an exemplary sequence diagram of procedures of content obtaining processing in the second embodiment; and

FIG. 12 is an exemplary sequence diagram of procedures of content obtaining processing in a modification.

### DETAILED DESCRIPTION

In general, according to one embodiment, an information processing apparatus includes an image capturing module, an estimation module, a content obtaining module, and a display module. The image capturing module is configured to capture a subject to be captured. The estimation module is configured to estimate a state of the subject to be captured based on a capturing method for the subject to be captured by the image capturing module. The content obtaining module is configured to obtain the content based on the state of the subject to be captured and relating to the subject to be captured. The display module is configured to display the obtained content.

### First Embodiment

An information processing apparatus 100 according to the present embodiment is an information processing apparatus comprising a display screen and is achieved as a tablet terminal, a slate terminal, or an electronic book reader, for example.

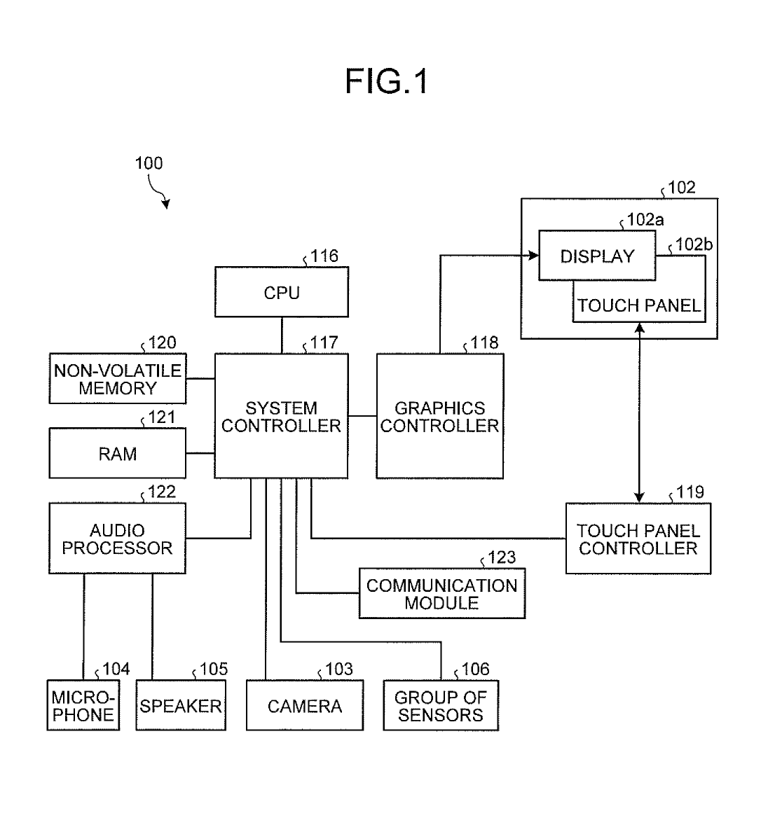

As illustrated in FIG. 1, the information processing apparatus 100 comprises a display module 102, a central processing unit (CPU) 116, a system controller 117, a graphics controller 118, a touch panel controller 119, a non-volatile memory 120, a random access memory (RAM) 121, an audio processor 122, a microphone 104, a speaker 105, a camera 103, a wireless communication module 123, and a group of sensors 106.

The display module 102 comprises a touch screen in which a display 102a and a touch panel 102b are combined. The display 102a is a liquid crystal display (LCD) or an organic light emitting display (OLED), for example. The touch panel 102b detects a position (the touched position) on a display screen of the display 102a that is touched by a user with a finger or a stylus pen.

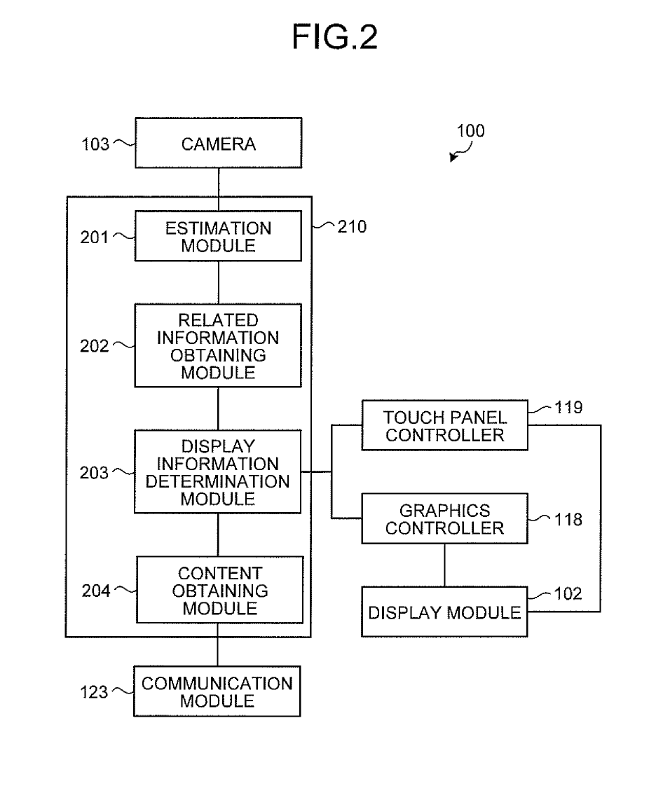

The non-volatile memory 120 stores therein an operating system, various application programs, and various types of data required for executing the computer programs. The CPU 116 is a processor for controlling operations of the information processing apparatus 100 and controls the components of the information processing apparatus 100 through the system controller 117. The CPU 116 executes the operating system and various application programs loaded from the non-volatile memory 120 to the RAM 121, thereby implementing functional modules, which will be described later (refer to FIG. 2). The RAM 121 provides a working area as a main memory of the information processing apparatus 100 used for the CPU 116 to execute the computer programs.

The CPU 116 executes the operating system and various application programs loaded from the non-volatile memory 120 to the RAM 121, thereby implementing the functions for controlling the modules and components of the information processing apparatus 100.

The system controller 117 incorporates a memory controller that controls access to the non-volatile memory 120 and the RAM 121. The system controller 117 has a function to communicate with the graphics controller 118, the touch panel controller 119, and the audio processor 122. The system controller 117 also has a function to input an image captured through the camera 103. Furthermore, the system controller 117 has a function to obtain various types of information from the outside of the information processing apparatus 100 using the communication module 123.

The graphics controller 118 is a display controller for controlling the display 102a of the display module 102. The touch panel controller 119 controls the touch panel 102b and obtains coordinate data representing the position touched by a user from the touch panel 102b.

The microphone 104 inputs sound and the speaker 105 outputs sound. The camera 103 is held over a subject to be captured by a user, then captures the subject and outputs the captured image.

The audio processor 122 performs processing for making the speaker 105 output voice guidance, for example, generated through audio processing such as audio composition under the control of the CPU 116 and performs processing on the sound collected by the microphone 104.

The communication module 123 executes wireless communication with an external device or communication through a network such as the Internet under the control of the CPU 116.

The group of sensors 106 comprises an acceleration sensor, an orientation sensor, and a gyro sensor, for example. The acceleration sensor detects the orientation and size of the acceleration on the information processing apparatus 100 from the outside. The orientation sensor detects the orientation of the information processing apparatus 100 and the gyro sensor detects the angular speed (rotation angle) of the information processing apparatus 100. Detection signals of the sensors are output to the CPU 116.

The CPU 116 and the computer programs stored in the non-volatile memory 120 (the operating system and various application programs) work together whereby the information processing apparatus 100 implements the modules of a functional module 210 illustrated in FIG. 2.

The information processing apparatus 100 has the function structure comprising, as illustrated in FIG. 2, the camera 103, the display module 102, the touch panel controller 119, a graphics controller 118, and the communication module 123 as described above. In addition, the information processing apparatus 100 comprises an estimation module 201, a related information obtaining module 202, a display information determination module 203, and a content obtaining module 204 as the functional module 210. In the embodiment, hereinafter, the display screen of the television is a subject to be captured by the camera 103.

The estimation module 201 estimates the state of the display screen of the television, which is a subject to be captured. The estimation module 201 executes processing such as image analysis, face recognition, object recognition, and letter recognition and estimates the state of the display screen of the television using the results of the processing.

The state of the display screen of the television is defined depending on an image capturing method, specifically, depending on how to hold the camera 103 to the display screen of the television. The state of the display screen of the television comprises the state of the display screen in the captured image (whether a part or whole of the display screen is displayed), the distance to the display screen from the camera 103, the orientation of the display screen, and the channel displayed on the display screen. In the embodiment, the content obtained and displayed differs depending on the state of the display screen of the television, i.e., depending on how to hold the camera 103 to the display screen of the television. This will be described later.

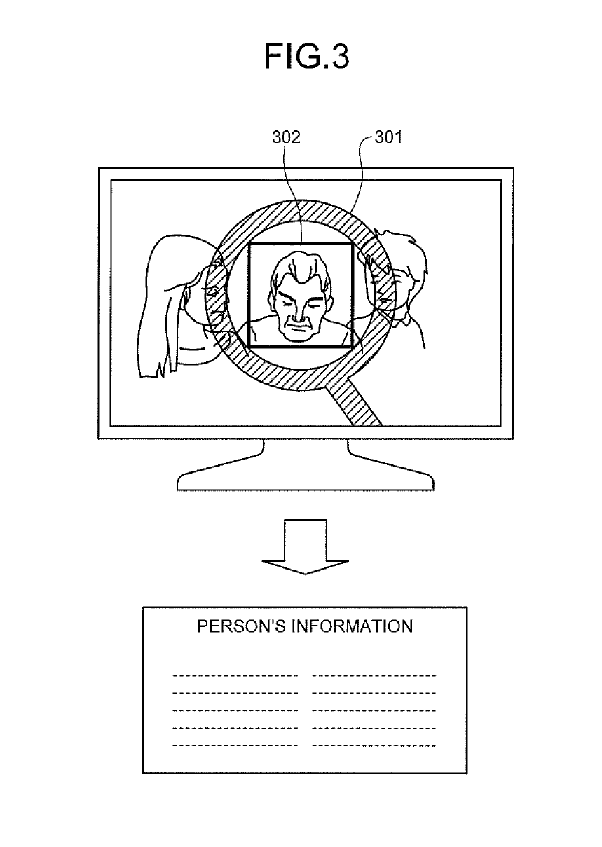

More specifically, when the setting is made so that the state of the subject to be captured is estimated for a part out of the entire captured image (an instruction range), the estimation module 201 performs image analysis on an image in the instruction range, thereby determining the display state of the display screen whether a part or whole of the display screen of the television is displayed in the instruction range. The instruction range is an area specifying the image for obtaining the content, on the captured image, and also serves to aim for an image analysis subject. In the embodiment, the instruction range is represented with the lens part of the magnifying glass symbol as illustrated in FIG. 3 (refer to the numeral 301). The instruction range, however, is not limited to this example. The instruction range may be the whole area of the captured image, rather than a part of the captured image.

The distance to the display screen represents the distance to the display screen of the television to which a user holds the camera 103, indicating whether the distance is long or short, i.e., the display is far or near. The estimation module 201 executes processing such as face recognition or object recognition in the instruction range of the captured image and determines the distance depending on the size of the face or object recognized. If the face or object is small, the distance is long, i.e., the display is far, and if the face or object is large, the distance is short, i.e., the display is near.

The state of the display screen may also be defined as a change in distance obtained by moving the camera 103 of the information processing apparatus 100 close to or away from the display screen of the television while holding the camera 103 of the information processing apparatus 100 to the display screen of the television.

An example of the operation moving the camera 103 of the information processing apparatus 100 close to or away from the display screen of the television while holding the camera 103 of the information processing apparatus 100 to the display screen is by physically moving the information processing apparatus 100 close to or away from the television. Another example is by virtually moving the information processing apparatus 100 close to or away from the television using a digital zoom function of the information processing apparatus 100. Specifically, when a subject to be captured is a large television, for example, it is difficult to physically move the information processing apparatus close to or away from the television because the distance between the user watching the television and the television is long. By using such a digital zoom function, the content can be displayed according to a similar manner of holding the information processing apparatus to the television as when physically moving the information processing apparatus 100 close to or away from the television.

Another example is by virtually moving the camera 103 close to the television to a predetermined distance using the digital zoom function, and then physically moving the camera 103 close to the display screen of the television while holding the camera 103 to the display screen of the television. By contrast, another example is by virtually moving the camera 103 away from the television to a predetermined distance using the digital zoom function, and then physically moving the camera 103 away from the display screen of the television while holding the camera 103 to the display screen of the television. Through the operations in these examples, the content can be displayed according to the similar manner of holding the information processing apparatus to the television as when physically moving the information processing apparatus 100 close to or away from the television. The advantageous effect can be achieved in that the magnification of the digital zoom function can be changed with an intuitive operation of physically moving the camera 103 close to or away from the display screen of the television.

Furthermore, physically moving the camera 103 of the information processing apparatus 100 close to or away from the display screen of the television while holding the camera 103 of the information processing apparatus 100 to the display screen of the television can trigger a change in the magnification of the digital zoom function of the camera, whereby the content can be displayed according to how the information processing apparatus is held to the television.

The orientation of the display screen represents whether the display screen of the television is captured while the display module 102 of the information processing apparatus 100 is held longitudinally or whether the display screen of the television is captured while the display module 102 of the information processing apparatus 100 is held transversely. The orientation of the display screen is determined depending on whether a user holds the information processing apparatus 100 longitudinally or transversely to the display screen of the television.

The estimation module 201 determines the orientation of the display module 102 using detection signals of the acceleration sensor and the gyro sensor of the group of sensors 106. The estimation module 201 performs processing of face recognition on a person or object recognition on an object in the captured image. From the rotational direction in the plane of the recognized face or object, the estimation module 201 determines the orientation of the display module 102 of the information processing apparatus 100. If it is determined that the face or object is horizontal with respect to the camera 103 according to the detection signals from the group of sensors 106, the estimation module 201 determines that the display module 102 is held transversely. If it is determined that the face or object is vertical with respect to the camera 103 according to the detection signals from the group of sensors 106, the estimation module 201 determines that the display module 102 is held longitudinally.

The estimation module 201 can use the angle between the camera 103 of the information processing apparatus 100 and the display screen, i.e., the angle at which the camera 103 is held to the display screen of the television as the state of the display screen of the television. That is to say, the estimation module 201 determines whether the camera 103 of the information processing apparatus 100 is held obliquely with respect to the display screen or held in front of the display screen, using the angle at which the camera 103 is held to the display screen of the television. The estimation module 201 detects the angle of the information processing apparatus 100, i.e., the angle at which the camera 103 is held to the display screen of the television, using detection signals of the acceleration sensor, the orientation sensor, and the gyro sensor of the group of sensors 106. If the difference between the detected angle and 90 degrees is small, the estimation module 201 determines that the camera 103 is held in front of the screen of the television. If the difference between the detected angle and 90 degrees is large, the estimation module 201 determines that the camera 103 is held obliquely with respect to the screen of the television.

The estimation module 201 analyzes an image in the instruction range of the captured image to estimate the channel according to the content of the program displayed on the captured image. This estimation of the channel may be achieved by the estimation module 201 to send the captured image to an external server that stores therein typical images for programs by channel and by time and query the server for channel.

The related information obtaining module 202 obtains related information according to the state of the display screen of the television and stores it in the RAM 121. The related information comprises a position a user can touch, electronic program guide (EPG) information for the position the user can touch, a uniform resource locator (URL) of the related content. The related information maybe stored in the non-volatile memory 120 in the information processing apparatus 100 in advance, or may be obtained by querying an external server device, for example.

The display information determination module 203 determines display information such as a frame, an icon, or video based on the state of the display screen of the television estimated by the estimation module 201 and the related information obtained by the related information obtaining module 202. The display information determination module 203 displays the determined pieces of the display information in the instruction range of the captured image displayed on the display module 102 in a manner the user can specify.

The content obtaining module 204 displays different contents depending on the state of the display screen of the television that are related to the part represented with the display information specified by the user on the display module 102. That is to say, the content obtaining module 204 obtains different contents depending on the state of the display screen such as the display state of the display screen, the distance to the display screen of the television, and the channel and displays the obtained content on the display module 102. The content obtaining module 204 obtains the content by referring to the related information stored in the RAM 121. The contents may be obtained internally from the information processing apparatus 100 or externally from the website on the Internet.

For example, if the estimation module 201 estimates that a part of the display screen is displayed in the instruction range, or the distance to the display screen is short (the display screen is close) as the state of the display screen, the content obtaining module 204 obtains information relating to a person comprised in the instruction range, as the content. By contrast, if the estimation module 201 estimates that whole of the display screen is displayed in the instruction range, or the distance to the display screen is long (the display screen is far) as the state of the display screen, the content obtaining module 204 obtains information relating to a program displayed in the instruction range, as the content. The information above may be obtained from a website of a free encyclopedia on the Internet or a website of the broadcasting station broadcasting the program.

Below is a description on how to hold the camera 103 to the display screen of the television and examples of the content displayed with reference to FIGS. 3 to 7.

As illustrated in FIG. 3, the estimation module 201 determines that a part of the display screen of the television is displayed in the instruction range 301, which is the lens part of the magnifying glass symbol, as the state of the display screen of the television. In other words, a user holds the camera 103 to the display screen of the television so that only a part of the display screen of the television is comprised in the instruction range 301. In this example, the estimation module 201 performs processing of face recognition on the person in the instruction range 301 and the related information obtaining module 202 obtains information of the URL of a website on which information on the person (e.g., an actor) in the instruction range 301 is described such as a website of a free encyclopedia, as the related information. As illustrated in FIG. 3, the display information determination module 203 determines a frame 302 as the display information and displays the frame 302 on the person in the instruction range 301 of the captured image. When the user touches the frame 302 to select the person, the content obtaining module 204 obtains the information of the selected person from the website obtained as the related information and displays the information as illustrated in FIG. 3.

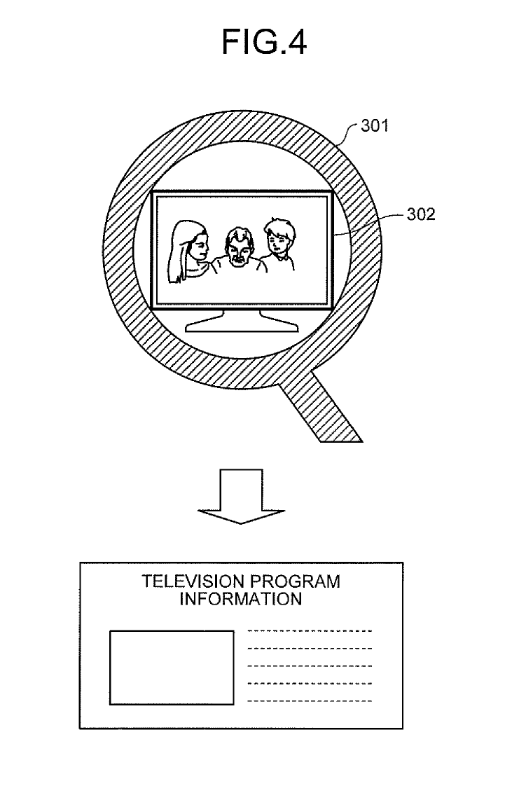

As illustrated in FIG. 4, the estimation module 201 determines that the whole of the display screen of the television is displayed in the instruction range 301 as the state of the display screen of the television, in other words, a user holds the camera 103 to the display screen of the television so that the whole of the display screen of the television is comprised in the instruction range 301. In this example, the estimation module 201 performs processing of image analysis on the image of the program in the instruction range 301 and the related information obtaining module 202 obtains information of the URL of the website on which information on the program in the instruction range 301 is described such as a website of a free encyclopedia, as the related information. As illustrated in FIG. 4, the display information determination module 203 determines a frame 302 as the display information and displays the frame 302 on the whole of the display screen in the instruction range 301 of the captured image. When the user touches the frame 302 to select the program, the content obtaining module 204 obtains the information on the selected program from the website obtained as the related information and displays the program information as illustrated in FIG. 4.

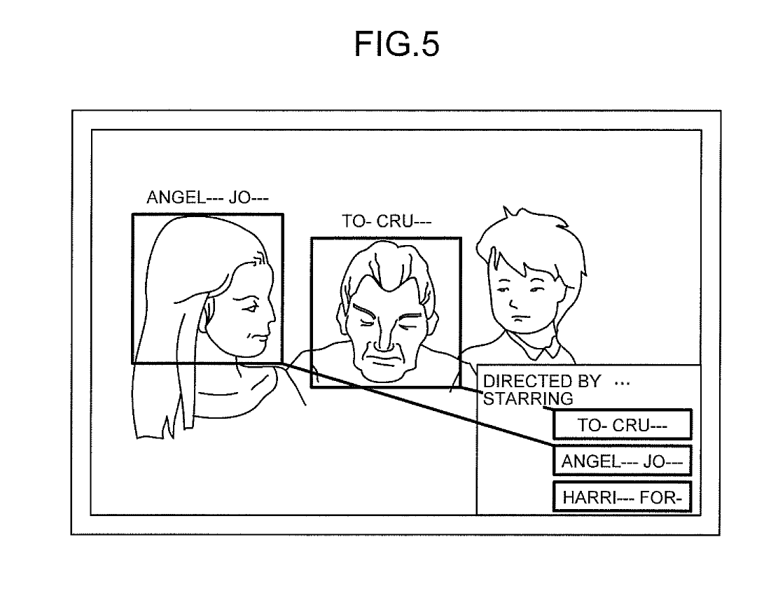

Alternatively, the related information obtaining module 202 may obtain a URL on an external electronic program server as the related information and the content obtaining module 204 may obtain the EPG information related to the program from the electronic program server. In this case, the content obtaining module 204 may display an image of the person comprised in the captured image and the information related to the character in the EPG information associated with each other on the display module 102, as illustrated in FIG. 5, as the content.

For another example, if the estimation module 201 determines that the whole of the display screen of the television is displayed in the instruction range 301 as the state of the display screen of the television, the content obtaining module 204 may obtain tweets on the program from Twitter®, camera images from different points of view through multiview in sport programs broadcasting baseball or soccer games, for example, or alternative programs, as the content and display these.

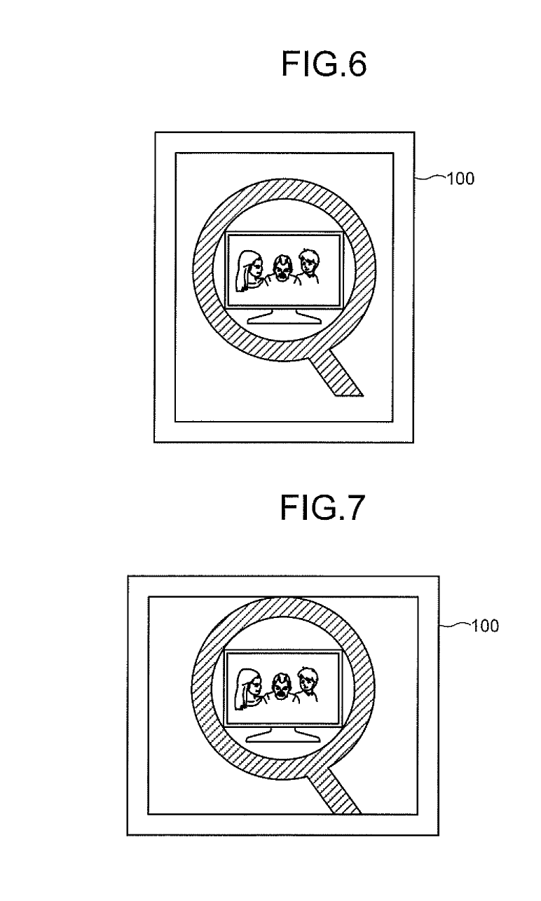

As illustrated in FIG. 6, the estimation module 201 determines that the display screen of the television is captured in the longitudinal state of the display module 102 as the state of the display screen of the television. In other words, a user holds the camera 103 longitudinally to the display screen of the television. In this example, the content obtaining module 204 obtains an image of the whole body of the selected person (e.g., an actor), with the touch operation, from the website obtained as the related information and displays the image.

Alternatively, as illustrated in FIG. 7, the estimation module 201 determines that the display screen of the television is captured in the transverse state of the display module 102 as the state of the display screen of the television. In other words, a user holds the camera 103 transversally to the display screen of the television. In this example, in the same manner when a part of the display screen is displayed in the instruction range 301, the content obtaining module 204 obtains an image of the person's information of the selected person (e.g., an actor) with the touch operation, from the website obtained as the related information and displays the person's information as illustrated in FIG. 3.

If the estimation module 201 determines that the distance to the display screen of the television becomes increasingly shorter as the state of the display screen of the television, in other words, starting from the state that the whole of the display screen is comprised in the instruction range, a user holds the camera 103 to the display screen of the television and moves the camera 103 increasingly closer to the display screen, the content obtaining module 204 obtains the information related to the specific person or object in the captured image and displays it instead of the information displayed when the whole of the display screen is comprised in the instruction range.

By contrast, if the estimation module 201 determines that the distance to the display screen of the television becomes increasingly longer as the state of the display screen of the television, in other words, starting from the state that a part of the display screen is comprised in the instruction range designated, a user holds the camera 103 to the display screen of the television and moves the camera 103 increasingly further away from the display screen, the content obtaining module 204 obtains the information of the entire program of the captured image and displays it instead of the information displayed when only a part of the display screen of the television is comprised in the instruction range.

If the estimation module 201 determines that a user holds the camera 103 obliquely to the display screen of the television, according to the angle between the camera 103 and the display screen as the state of the display screen of the television, the content obtaining module 204 obtains camera images from different points of view through the multiview in sport programs broadcasting baseball or soccer games, for example, according to the angle between the camera 103 and the display screen, and displays the images.

If a user holds the camera 103 over an image of clothes displayed on an online shopping site or clothes a person (e.g., an actor) appearing in the program (e.g., a drama) wears to specify the clothes in the image, the content obtaining module 204 may display a website of the dealer shop of the clothes, a map to the dealer shop of the clothes, or an e-commerce website selling the clothes as the content.

Alternatively, if a user holds the camera 103 over an image of dishes broadcasted in a trip-and-eat program to specify the dishes in the image, the content obtaining module 204 may display a website of the restaurant providing the dishes or a map to the restaurant providing the dishes as the content.

Furthermore, if a user selects the sentence “check website for more details”, for example, in the captured image in a commercial message (CM), the content obtaining module 204 may display the website providing the rest of the CM as the content.

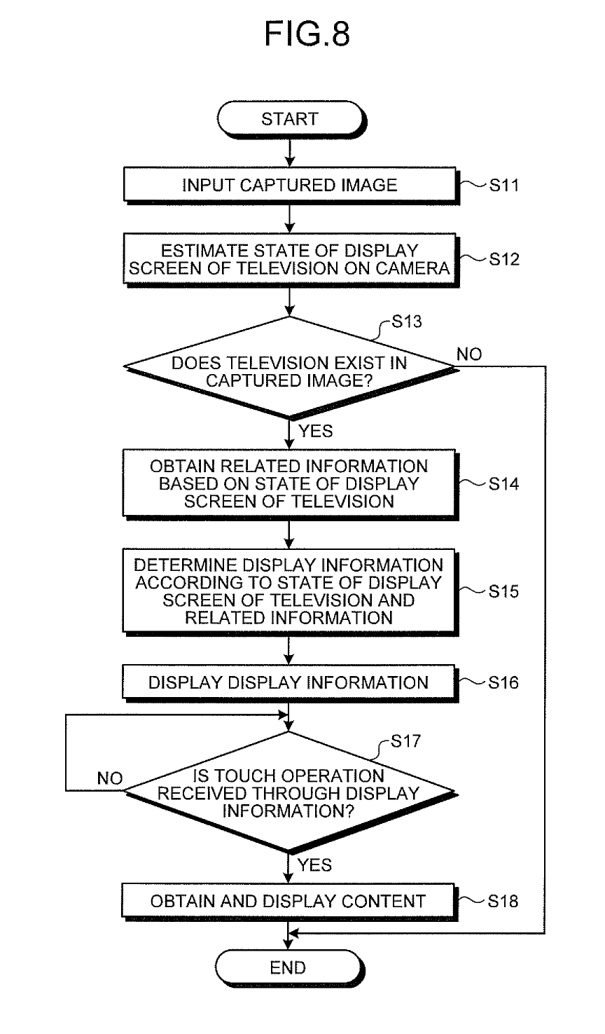

The content display processing in the embodiment will now be described with reference to FIG. 8. Firstly, the estimation module 201 inputs the captured image from the camera 103 (S11) and then estimates the state of the display screen of the television, as described above (S12).

Subsequently, the related information obtaining module 202 determines whether any display screen of the television exists in the captured image (S13). If no display screen of the television exists in the captured image (No at S13), the processing ends.

If any display screen of the television exists in the captured image (Yes at S13), the related information obtaining module 202 obtains the related information based on the state of the display screen of the television (S14). The display information determination module 203 determines the display information according to the state of the display screen of the television and the related information (S15) and displays the determined display information on the captured image displayed on the display module 102 (S16).

The content obtaining module 204 changes to a standby state for a touch operation by a user for selecting a piece of display information (S17, No at S17). When a touch operation is received, (Yes at S17), the content obtaining module 204 obtains the content with reference to the related information and displays it on the display module 102 (S18).

In the embodiment, as described above, because the content is obtained depending on how the camera 103 is held to the display screen of the television by a user, the user can readily and intuitively search for the content based on the preferred subject.

### Second Embodiment

In the first embodiment, estimation of the state of the display screen of the television, obtainment of the related information, determination of the display information, and obtainment of the content are performed in the information processing apparatus 100. In the second embodiment, they are performed in a server device.

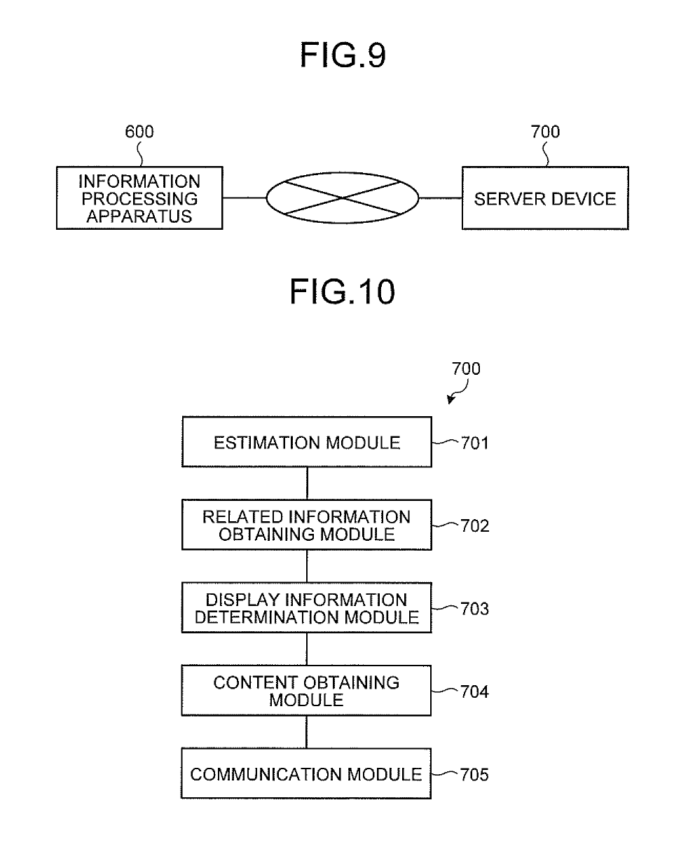

In the second embodiment, as illustrated in FIG. 9, an information processing apparatus 600 and a server device 700 are coupled to each other through a network such as the Internet.

The hardware structure of the information processing apparatus 600 according to the second embodiment is the same as the information processing apparatus 100 according to the first embodiment. The server device 700 according to the second embodiment has the hardware structure using a typical computer. The server device 700 comprises a CPU, a storage device such as a ROM and a RAM, an external storage device such as an HDD and a CD-ROM drive, a display module such as a display device, and an input device such as a keyboard and a mouse.

As illustrated in FIG. 10, the server device 700 in the second embodiment mainly comprises an estimation module 701, a related information obtaining module 702, a display information determination module 703, a content obtaining module 704, and a communication module 705 as a function structure.

The functions of the estimation module 701, the related information obtaining module 702, the display information determination module 703, and the content obtaining module 704 are the same as the estimation module 201, the related information obtaining module 202, the display information determination module 203, and the content obtaining module 204 of the information processing apparatus 100 in the first embodiment. The communication module 705 transmits and receives various types of data to and from the information processing apparatus 600.

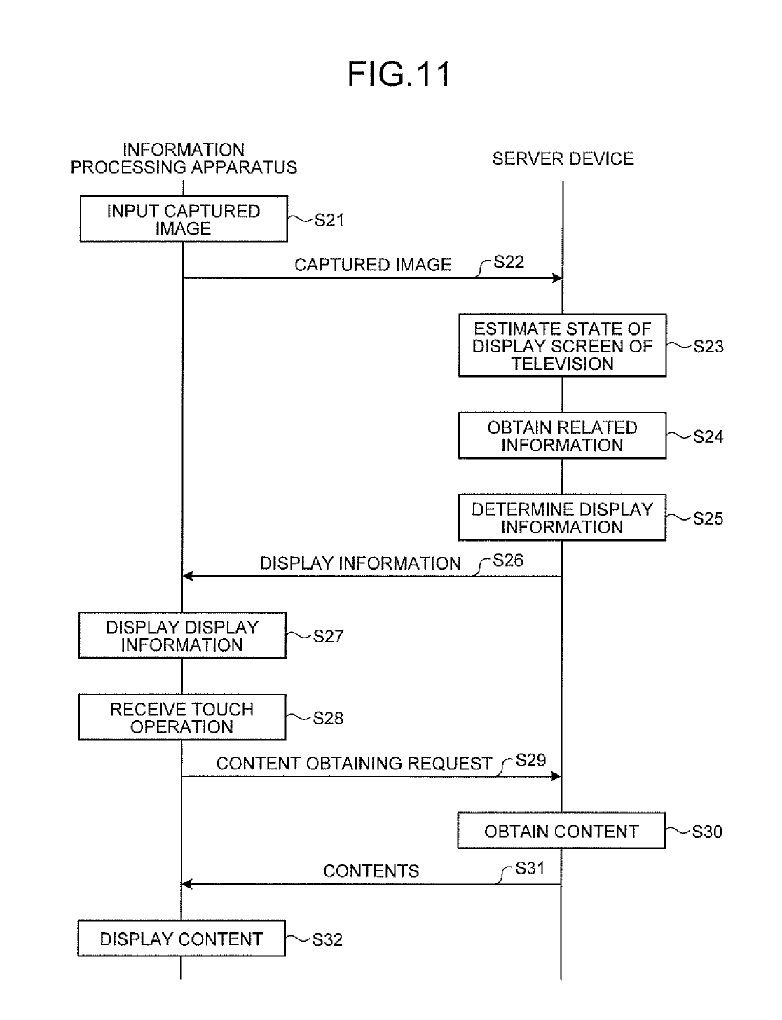

The content obtaining processing in an information processing system according to the second embodiment will now be described with reference to FIG. 11.

Firstly, the information processing apparatus 600 inputs the captured image through the camera 103 (S21) and then transmits the input captured image to the server device 700 (S22).

In the server device 700, the communication module 705 receives the captured image and the estimation module 701 estimates the state of the display screen of the television based on the captured image (S23). At this point, in the information processing apparatus 600, the group of sensors 106 may detect operations of the information processing apparatus 600 by itself to estimate the state of the display screen.

Subsequently, the related information obtaining module 702 obtains the related information based on the state of the display screen of the television, like in the first embodiment (S24). The display information determination module 703 determines the display information according to the state of the display screen of the television and the related information (S25) and the communication module 705 transmits the determined display information to the information processing apparatus 600 (S26).

After receiving the display information, the information processing apparatus 600 displays the display information on the display module 102 (S27) and receives touch operation for selection by a user (S28). After receiving a touch operation for selection by a user, the information processing apparatus 600 transmits a content obtaining request for the selected image to the server device 700 (S29).

After the content obtaining request is received in the server device 700, the content obtaining module 704 obtains the content related to the image specified by the content obtaining request (S30) and the communication module 705 transmits the obtained content to the information processing apparatus 600 (S31).

The information processing apparatus 600 receives the content from the server device 700 and displays the received content on the display module 102 (S32).

As described above, in the second embodiment, estimation of the state of the display screen of the television, obtainment of the related information, determination of the display information, and obtainment of the content are performed in the server device 700. This can provide similar advantageous effects to those in the first embodiment, and reduce the processing load in the information processing apparatus 600.

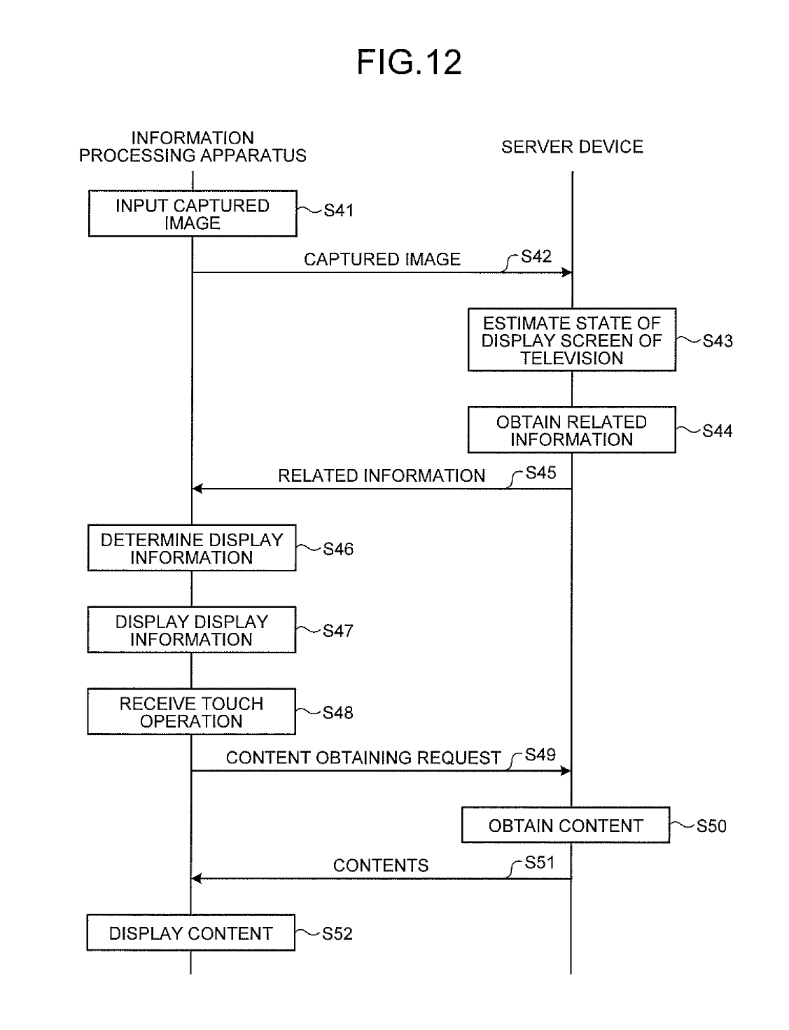

In the second embodiment, estimation of the state of the display screen of the television, obtainment of the related information, determination of the display information, and obtainment of the content are all performed in the server device 700. The embodiment, however, is not limited to this example and a part of them may be performed in the information processing apparatus 600 and others may be performed in the server device 700. Specifically, as illustrated in FIG. 12, determination of the display information (S46) may be performed in the information processing apparatus 600 and estimation of the state of the display screen of the television (S43), obtainment of the related information (S44), and obtainment of the content (S50) may be performed in the server device 700. The processing of other steps (S41, S42, S43, and S47 to S52) are performed in the same manner as in the third embodiment.

In the embodiments described above, the display module 102 has a touch screen function, however, the display module 102 is not limited to this example and may be a typical display module without a touch screen function.

Furthermore, in the embodiments described above, the content is obtained after determination and display of the display information and a user selection for the state of display. The content, however, may be obtained according to the state of the display screen, relating to the display screen of the television, without the determination, display, and the user selection for the state of display.

The computer program executed in the information processing apparatus 100 in the embodiment described above may be provided as a computer program product in a manner recorded as an installable or executable file format in a computer-readable recording medium, such as a compact disk read-only memory (CD-ROM), a flexible disk (FD), a compact disk recordable (CD-R), and a digital versatile disk (DVD).

The computer program executed in the information processing apparatus 100 in the embodiment described above may be provided in a manner stored in a computer connected to a network such as the Internet so as to be downloaded through the network. The computer program executed in the information processing apparatus 100 in the embodiment described above may also be provided or distributed over a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
an image capturing module configured to capture a subject to be captured;
an estimation module configured to estimate a state of the subject to be captured based on a capturing method for the subject to be captured by the image capturing module;
a content obtaining module configured to obtain the content based on the state of the subject to be captured and relating to the subject to be captured; and
a display module configured to display the obtained content.

2. The information processing apparatus of claim 1, further comprising:
a related information obtaining module configured to obtain related information based on the state of the subject to be captured; and
a determination module configured to determine display information based on the subject to be captured and the related information, wherein
the display module is configured to display the display information in a manner a user can specify, and
the content obtaining module is configured to obtain the content based on the display information specified by the user.

3. The information processing apparatus of claim 2, wherein the subject to be captured is a display screen.

4. The information processing apparatus of claim 3, wherein the content obtaining module is configured to obtain different contents depending on whether a part or whole of the display screen is specified to be displayed in the captured image captured by the image capturing module.

5. The information processing apparatus of claim 4, wherein when a part of the display screen is specified to be displayed in the captured image, the content obtaining module is configured to obtain information related to a person comprised in a part of the display screen as the content.

6. The information processing apparatus of claim 4, wherein when the whole of the display screen is specified to be displayed in the captured image, the content obtaining module is configured to obtain information related to a program displayed on the display screen as the content.

7. The information processing apparatus of claim 6, wherein
the content obtaining module is configured to receive electronic program guide information as information related to the program, and
the display module is configured to display an image of a person comprised in the captured image and information related to a character in the electronic program information associated with each other as the content.

8. The information processing apparatus of claim 3, wherein the content obtaining module is configured to obtain different contents depending on the orientation of the display screen as the state of the display screen.

9. The information processing apparatus of claim 3, wherein the content obtaining module is configured to obtain different contents depending on the channel of the program displayed on the display screen as the state of the display screen.

10. A server device, comprising:
a receiving module configured to receive a captured image captured by an image capturing module of an information processing apparatus coupled to a network;
an estimation module configured to estimate a state of a subject to be captured based on a capturing method for the subject to be captured by the image capturing module;
a content obtaining module configured to obtain content based on the state of the subject to be captured and relating to the subject to be captured; and
a transmission module configured to transmit the obtained content to the information processing apparatus.

11. A computer program product having a non-transitory computer readable medium including programmed instructions, wherein the instructions, when executed by a computer, cause the computer to perform:
estimating a state of the subject to be captured based on a capturing method for the subject to be captured by the image capturing module;
obtaining content based on the state of the subject to be captured and relating to the subject to be captured; and
displaying the obtained content.
